(19) United States
(12) Patent Application Publication
(10) Pub. No.: US 2012/0330096 A1
(43) Pub. Date: Dec. 27, 2012

(54) VACUUM SUCTION TISSUE STABILIZING DEVICE

(75) Inventors: Alison M. Stace-Naughton, Madison, WI (US); Brenna M. Gibbons, Los Altos Hills, CA (US); Scott A. Snyder, Hanover, NH (US); Ihab Basri, Hanover, NH (US)

(73) Assignee: SPIRAL-E SOLUTIONS, LLC, Madison, WI (US)

(21) Appl. No.: 13/530,579

(22) Filed: Jun. 22, 2012

Related U.S. Application Data
(60) Provisional application No. 61/500,285, filed on Jun. 23, 2011.
(60) Provisional application No. 61/559,365, filed on Nov. 14, 2011.

(51) Int. Cl. A61H 7/00

(52) U.S. Cl. 600/37

(57) ABSTRACT

A system is provided for the control of soft tissues, the system having a negative pressure supply; a negative pressure applicator, coupled to the negative pressure supply and configured to apply a negative pressure to the soft tissue, atraumatically and releasably securing the soft tissue to the negative pressure applicator; and the rigid negative pressure supply being configured to be disposed in an access port without inhibiting the insertion and manipulation of an surgical instrument.

### RELATED APPLICATIONS

This application claims the benefit of U.S. Provisional Applications No. 61/500,285, filed Jun. 23, 2011, and No. 61/559,365, filed Nov. 14, 2011. Each of these applications is herein incorporated by reference in their entirety for all purposes.

### FIELD OF THE INVENTION

The invention relates to endoscopic surgical devices, and more particularly, to an endoscopic surgical device configured to assist with tissue stabilization with suction.

### BACKGROUND OF THE INVENTION

Natural orifice translumenal endoscopic surgery is a cutting-edge, minimally invasive procedure in which surgeons operate through natural orifices such as the mouth. This pioneering technique eliminates the need to make a skin incision, resulting in a faster recovery time and less scarring. It however, limits the ability of the surgeon to positively and a traumatically hold tissue to be operated upon.

Some limitations of the known technologies for tissue stabilization are focused on tissue manipulator devices inability to stabilize tissue. Essentially, a flexible, slippery internal organ or surface of an organ must be held immobile relative to other tools which could, in certain instances, be used to manipulate, move, cut, cauterize, suture, or prepare for removal of certain types of tissues.

Some such systems use mechanical graspers which often fail to adequately create a purchase of the tissue with enough force to serve as a tissue manipulation device. Other such systems cause local tissue damage and internal trauma.

Furthermore, in minimally invasive procedures, and especially in natural orifice endoscopy, the number of access points opened or utilized through the patients' skin or orifices are naturally limited. It is often impossible, and certainly highly undesirable, to have more than two or three openings through the patient's body to access the surgical site. One skilled in the art will appreciate that new flexible endoscopic devices will only increase the desirability to stabilize and secure tissue without increasing the number of access ports.

What is needed, therefore, are techniques for allowing for positive and atraumatic manipulation of tissues in minimally invasive surgeries without limiting range of motion, and while not occupying an additional access port.

### SUMMARY OF THE INVENTION

One embodiment of the present invention provides a system for the control of soft tissues, the system having: a negative pressure supply, a negative pressure applicator, coupled to the negative pressure supply and configured to apply a negative pressure to the soft tissue, atraumatically and releasably securing the soft tissue to the negative pressure applicator, and The negative pressure supply being configured to be disposed in an access port without inhibiting the insertion and manipulation of a surgical instrument.

Another embodiment of the present invention provides such a system wherein the negative pressure supply comprises a section of biocompatible surgical tubing.

A further embodiment of the present invention provides such a system wherein the negative pressure applicator comprises an end piece having a negative pressure disseminating cavitation disposed on a side proximal to the soft tissue.

Still another embodiment of the present invention provides such a system wherein the cavitation is a groove.

A still further embodiment of the present invention provides such a system wherein at least a portion of the rigid negative pressure supply is a helical portion and the inner diameter of the helical portion is configured to receive the surgical instrument.

Yet another embodiment of the present invention provides such a system wherein the helical portion allows the endoscopic instrument rotational movement in not less than about approximately 300° around the major axis of the surgical instrument.

A yet further embodiment of the present invention provides such a system further comprising a tissue interface disposed on a side of the negative pressure applicator proximal to the tissue.

Even another embodiment of the present invention provides such a system wherein the issue interfaces is a compliant material.

An even further embodiment of the present invention provides such a system wherein the negative pressure applicator is an annular member having an internal lumen to be disposed about an operative site.

Still yet another embodiment of the present invention provides such a system wherein the negative pressure applicator comprises a plurality of negative pressure applicator members configured to be disposed symmetrically around at least a portion of an operative site.

A still yet further embodiment of the present invention provides such a system wherein the negative pressure applicator comprises a plurality of negative pressure applicator members configured to be disposed asymmetrically around at least a portion of an operative site.

An even still another embodiment of the present invention provides such a system further comprising at least a portion of the negative pressure supply is compliant, such that negative pressure applicator is held normal to the soft tissue.

An even still further embodiment of the present invention provides such a system wherein the negative pressure supply is flexible.

Yet even another embodiment of the present invention provides such a system wherein the negative pressure supply is rigid.

An yet even further embodiment of the present invention provides such a system further comprising a second negative pressure supply.

Yet still even another embodiment of the present invention provides such a system further comprising a second negative pressure applicator coupled to the second negative pressure supply.

One embodiment of the present invention provides a method for the manipulation of soft tissue, the method comprising: disposing a negative pressure applicator proximate to a surgical site in soft tissue, the negative pressure applicator being coupled to a negative pressure supply; applying a negative pressure to the soft tissue thereby applying traction to the surgical site; inserting a surgical instrument through a central axis of the helical rigid negative pressure supply; and manipulating tissue at the surgical site.

Another embodiment of the present invention provides such a method wherein the negative pressure supply is rigid.

A further embodiment of the present invention provides such a method wherein the negative pressure supply is helical.

Still another embodiment of the present invention provides such a method further comprising manipulating the surgical instrument outside of a circumference of the helical rigid negative pressure supply.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and should not be construed to limit the scope of the inventive subject matter in any manner.

### BRIEF DESCRIPTION OF THE DRAWINGS

FIG. 1 is a elevation view of a tissue manipulation system configured in accordance with one embodiment of the present invention.

FIG. 2 is a perspective view of a tissue manipulation system configured in accordance with one embodiment of the present invention.

FIG. 3 is a plan view of an end piece of tissue manipulation system configured in accordance with one embodiment of the present invention.

FIG. 4 is a perspective view of an end piece segment of tissue manipulation system configured in accordance with one embodiment of the present invention.

FIG. 5 is a plan view of an end piece segment with a guide ring of a tissue manipulation system configured in accordance with one embodiment of the present invention.

FIG. 6 is a exploded perspective view of an end piece of tissue manipulation system configured in accordance with an alternative embodiment of the present invention.

FIG. 7 is a perspective view of two mated end piece segments of a tissue manipulation system configured in accordance with one embodiment of the present invention.

FIG. 8 is a perspective view of an end piece segment of a tissue manipulation system configured in accordance with one embodiment of the present invention configured to receive a supply at an angle.

FIG. 9 is a perspective view of an end piece of a tissue manipulation system configured in accordance with one embodiment of the present invention configured to receive multiple supply lines orthogonal to the end piece.

FIG. 10 is a plan view of an end piece of a tissue manipulation system configured in accordance with one embodiment of the present invention configured to receive multiple supply lines orthogonal to the end piece.

FIG. 11 is a perspective view of a tissue manipulation system configured in accordance with one embodiment of the present invention configured to receive multiple supply lines at an angle to the end piece.

FIG. 12 is a perspective view of a tissue manipulation system configured in accordance with one embodiment of the present invention configured to receive multiple supply lines at an angle to the end piece where two end piece units are inserted separately.

FIG. 13 is a perspective view of a tissue manipulation system configured in accordance with one embodiment of the present invention configured to receive two straight negative pressure supply lines.

FIG. 14 is a perspective view of a tissue manipulation system configured in accordance with one embodiment of the present invention configured to receive two helical negative pressure supply lines.

FIG. 15 is a bottom plan view of a tissue manipulation system end piece configured in accordance with one embodiment of the present invention configured to receive two negative pressure supply lines.

FIG. 16 is a bottom plan view of a tissue manipulation system end piece configured in accordance with an alternative embodiment of the present invention configured to receive two negative pressure supply lines.

FIG. 17 is a perspective view of a tissue manipulation system end piece configured in accordance with an alternative embodiment of the present invention configured with an internal slope or chamfer.

### DETAILED DESCRIPTION

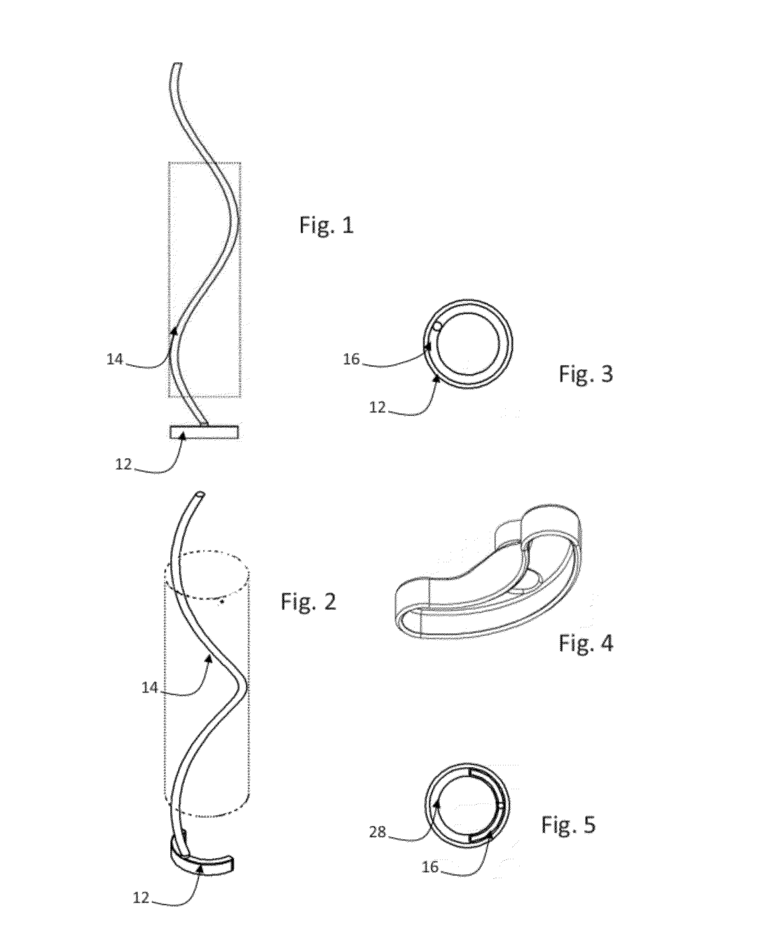

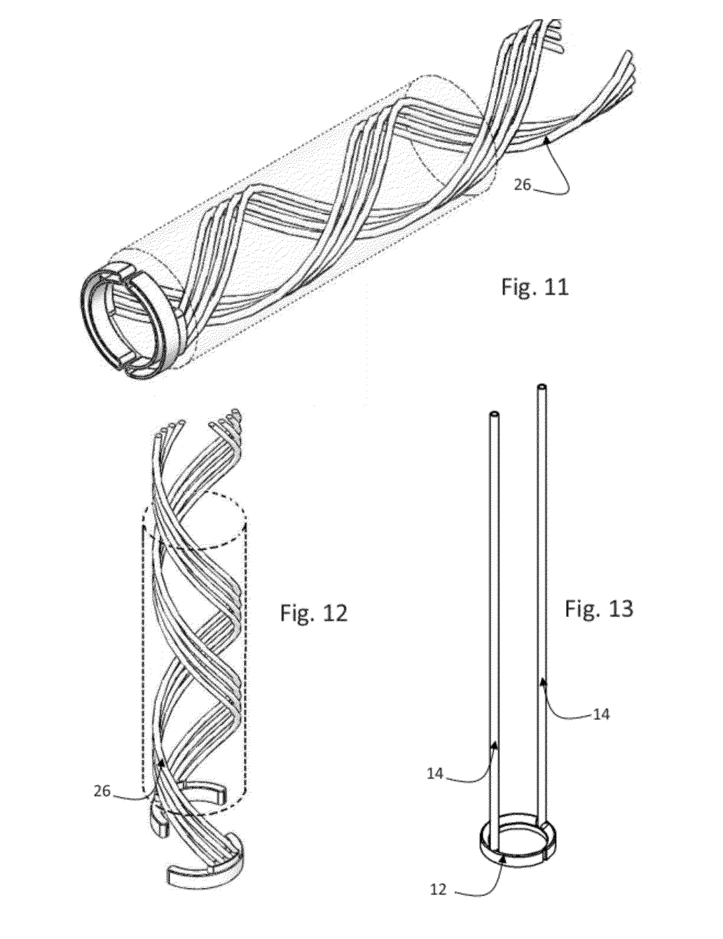

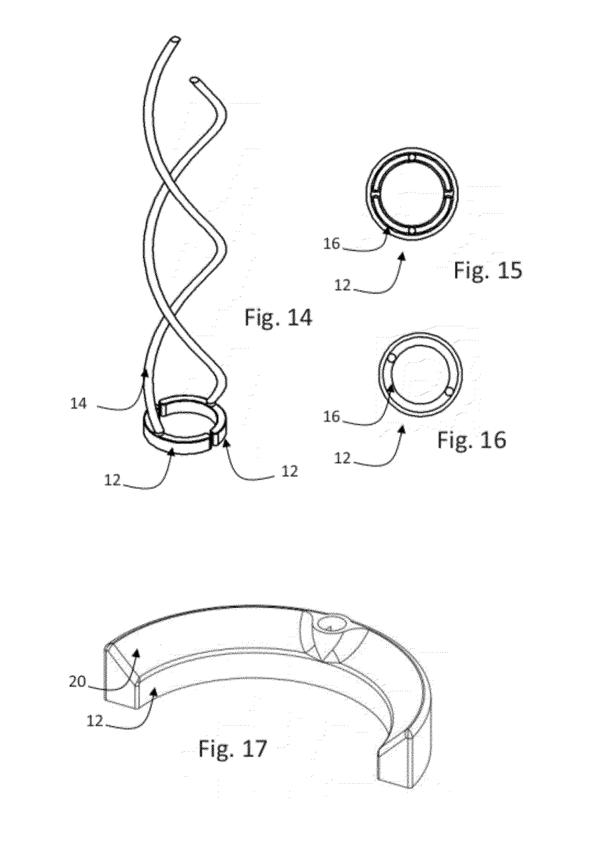

One embodiment of the present invention, illustrated in FIG. 1, provides a system for manipulation of tissues through a port at a operative site, the system having: a suction applicator 12; in one embodiment it is annular or ring-like, as illustrated in detail in FIG. 3, end piece 12 coupled to a suction or negative pressure supply 14 at a first end of said suction supply 14 which is itself and a suction source (not shown) at a second end; the suction applicator 12 being configured with a suction distribution groove 16 on a surface proximate to the tissues. Alternative suction or negative pressure applicators 12 may be configured to apply negative pressure only from one side rather than from a complete ring, as in FIGS. 2 and 5 or may apply negative pressure at a point location. While in one embodiment, a suction distribution groove 16 may be supplied, suction or negative pressure may be applied to the tissue through a variety of structures, including grooves, manifolds, concavities, or other structures configured to localize reductions in pressure to atraumatically and removably secure soft tissue to the applicator 12. As illustrated in FIG. 13, the supply may be straight, and may comprise a plurality of lines in an array 26 as in FIGS. 11 and 12. In such an embodiment supply lines in the array 26 may either couple to a common grove 16 or may be coupled to discrete grooves 16.

In one embodiment, a suction applicator is a device configured to atraumatically and securely or positively engage flexible tissue. Such a suction applicator as a term may be construed to include the entire system of: Communicating a suction from outside the patient/operative field to inside the patient at the surgery site. A suction supply having multiple forms that deliver the negative pressure from outside the patient to inside at the operative site, such a connection having multiple features for engagement between the suction delivery apparatus and the rigid or flexible tool with which it is coupled or used in conjunction with, i.e., rigid endoscope, flexible endoscope, rigid or flexible tool (if not an endoscope) used by a clinician to manipulate, intervene with, observe, or otherwise effect an action upon target tissue. The connection may also stand alone as a separate device without an accompanying paired device.

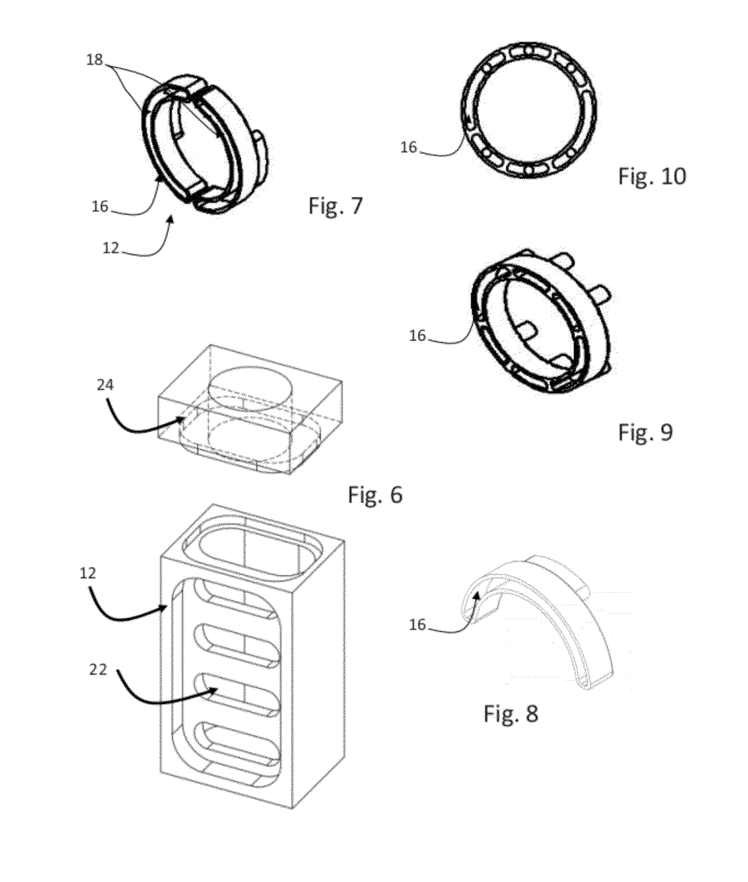

Another embodiment of the present invention provides a system for manipulation by endoscopic or other remote means of tissues at an operative site, the system having: a suction applicator 12; a suction supply coupled to the suction applicator 12, a suction or negative pressure applicator being a device whereby a negative pressure is applied to a tissue, at a first end and a suction source at a second end; the suction applicator 12 being configured in a rectangular shape, such as that illustrated in FIG. 6 with a suction distribution grove on one surface proximate to the tissue. In such an embodiment, a plurality of appertures 22 may be disposed in the side of the end piece 12, while an adaptor 24 may allow for coupling to the supply (not shown in FIG. 6). Various embodiments of the invention utilize various suction applicator 12 designs that can be used depending on the specific needs of the access port to approach the tissue. Access ports used may be laparoscopic, endoscopic, or natural orifices resulting in minimal or non-invasive surgical techniques. These end piece 12 designs range from a smoothed-edge rectangular piece as in FIG. 6 with one side of suction to an oval shape with one side having suction. In one embodiment the foot or end piece of the applicator 12 may be configured with an internal ramp 20 as illustrated in FIG. 17 that allows for easier insertion of a paired device into and along the central axis defined by the center of the longitudinal axis of the present invention,

In one embodiment, the supply line 14 of the device is configured to allow the surgeon to access the tissue from multiple angles thereby not overly constraining the surgeon's freedom of motion. This ability is facilitated by configuring the negative pressure supply 14 in a helical configuration. This not only allows the surgeon to manipulate the incision and surrounding tissue, but also improves access proximate to the incision and surrounding tissue from approaches not currently accessible with existing devices. Negative pressure applied to the tissue places the tissue in traction, and the traction on the tissue atraumatically compresses the tissue proximate to the surgical field preventing the flow of biological fluids into the incision, resulting in increased efficacy and reduction in risk of adverse complications. In one embodiment such a system should allow for ex-situ or in-situ assembly as the clinician desires.

As illustrated in FIG. 12 such an in situ installation is provided where the applicator comprises a plurality of segments 18, each segment 18 is equipped with its own supply 14. Indeed, alternative embodiments are provided wherein a plurality of supplies is applied to each segment 18 as illustrated in FIG. 10.

In one embodiment, the supply line 14 is configured from a spiral or helix of medical grade tubing of either plastic, such as that sold under the brand name Tygon by Saint-Gobain S. A. (no claim is made to the trademark Tygon), or biocompatible metal like stainless steel or other suitable tubing that is both biocompatible and suitably resistant to deformation. Such a supply line provides vacuum pressure without overly constraining the freedom of rotation of a device inserted through the center axis of the helix, allowing a flexible device to be manipulated outside of the radius of the helix. The tubing, of one embodiment, (either spiraled or straight) is rigid so that it can stand on its own. In an alternative embodiment, may be a combination of rigid and flexible tubing so that the endoscope can work with the device more easily.

The stainless steel (or other biocompatible material) end piece or applicator may have several different groove and suction designs depending on the particular application. As illustrated in FIGS. 3-5, 7-10, and 15-17 the end piece is end piece 12 is susceptible to a variety of embodiments. The end piece may comprise a partial or complete annular or ring like structure. One or more end pieces 12 may be deployed to form a ring like structure or partial rings may be deployed without additional end pieces. In embodiments where more than one end piece is used, or where more than one end piece is mated to form a ring, separate negative pressure supply lines 14 are deployed for each end piece 12 or end piece segment. Additionally, in embodiments with only a partial suction applicator, a cover ring 28 may be deployed to aid in the deployment of surgical instruments in the surgical field. These designs range from a circular groove which allows for even suction around the incision in order to lift and stabilize the tissue to apertures 22, as in FIG. 6 to directly engage tissue, where the aperture, in various embodiments is sized to be small relative to the tissue size being operated upon.

Another embodiment involves the suction supply 14 coupled with a suction applicator 12 being configured in a rectangular shape with a suction distribution grove on one surface proximate to the tissue. One skilled in the art will appreciate that materials other than stainless steel may be used, having suitable stability, including, but not limited to biocompatibility, structural integrity, and machine-ability (ease of manufacture). The end pieces 12 are designed to be sufficiently deep to prevent clogging by tissue, as illustrated in FIG. 4. The outer diameter, of one embodiment is configured to permit the device to slide easily into the overtube during insertion of the device. In one embodiment, the groove's cross-section may be semi-circular, while alternative embodiments may have cross sections of different geometry. The inner diameter will allow a standard, therapeutic endoscope or other surgical device of with a diameter of small enough to traverse the device and enter the peritoneal cavity through the incision. The materials for this device were chosen based on several key specifications, including friction coefficient and tensile strength.

This design also has an additional benefit: in addition to stabilization of the tissue, the suction may act to prevent the flow of acidic gastric fluids into the peritoneal cavity by collecting fluids from the surgical site. This is another of the main concerns expressed by critics of endoscopic procedures, and one that no other tissue stabilization device addresses.

In one embodiment of the present invention, illustrated in FIG. 1 the tubing (spiral, curved or straight depending on the embodiment of the invention) provides suction to an endpiece which rests on the tissue. This design dramatically improves the freedom of movement of the endoscope or surgical tools, allowing it to turn approximately not less than approximately 300° and access the tissue from any angle, as well as from a range of heights. The supply line design also allows the device to simply slide into an existing overtube and be extended out the end to the precise depth the surgeon desires. The device may be inserted separately from the overtube, reducing the risk of potential damage to the patient's throat during this step.

The tubing (spiral or straight) in one embodiment is configured to maximize the ability for the endoscope to escape the constraints of the device and work in the body cavity.

The material properties used in various embodiments of the present invention may be altered to address specific design requirements. A consideration of one embodiment was that the device would be flexible enough to fit through the body cavity (i.e. down a throat) without breaking, and would still maintain good vacuum suction.

The system of the various embodiments of the present invention provides:
Secure engagement with the tissue
Distribution of force so as not to cause excessive suction force on any one area of tissue, but spread suction force over a larger area of tissue, thereby preventing the creation of suction hematoma or other tissue damage.
Distribution vacuum delivery means as a means of providing a backup suction effect in the event that one or more other vacuum delivery means become clogged by tissue or other occludent.

In one embodiment, a system can be provided with an interface layer. An Interface Layer, is comprised of material that has a more pliant/compliant/modulus of elasticity designed to engage with the tissue without providing overly hard or sharp surfaces that can cause tissue damage

The tissue engagement via the negative pressure applicator may be configured in various ways, both symmetrically, i.e., two semi-hemispherical arcs disposed uniformly on either side of the central operative site, or in an asymmetrical manner with non-uniform features designed to engage with tissue that abuts adjacent to other tissue structures, and does not allow for symmetrical engagement.

In one embodiment, a connection between the Vacuum Delivery apparatus and the Tissue Engagement Apparatus allows for angular displacement of the Vacuum Delivery relative to the Tissue Engagement, such that the Tissue Engagement devices may seek a normal (i.e., perpendicular) angle relative to the tissue in its immediate distal vicinity, thus enhancing tissue engagement, completing a full suction/vacuum engagement, and preventing or decreasing the likelihood of the tissue engagement means causing trauma or failing to adequately secure to the tissue. In such an embodiment, the end piece or applicator may be coupled to the supply by a section of flexible tubing, a hinged joint, a ball joint, a segmented metal coupling or snake, or other flexible coupling.

One skilled in the art will appreciated that alternative embodiments of the present invention could easily be made using different materials, geometries of the end piece, and its material properties such as tensile strength and spring constant values.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

We claim:

1. A system for the control of soft tissues, said system comprising:
a negative pressure supply;
a negative pressure applicator, coupled to said negative pressure supply and configured to apply a negative pressure to said soft tissue, atraumatically and releasably securing said soft tissue to said negative pressure applicator; and
said negative pressure supply being configured to be disposed in an access port without inhibiting the insertion and manipulation of a surgical instrument.

2. The system of claim 1 wherein said negative pressure supply comprises a section of biocompatible surgical tubing.

3. The system of claim 1 wherein said negative pressure applicator comprises an end piece having a negative pressure disseminating cavitation disposed on a side proximal to said soft tissue.

4. The system of claim 3 wherein said cavitation is a groove.

5. The system of claim 1 wherein at least a portion of said rigid negative pressure supply is a helical portion and the inner diameter of said helical portion is configured to receive said surgical instrument.

6. The system of claim 5 wherein said helical portion allows said endoscopic instrument rotational movement in not less than about approximately 300° around the major axis of said surgical instrument.

7. The system of claim 1 further comprising a tissue interface disposed on a side of said negative pressure applicator proximal to said tissue.

8. The system of claim 7 wherein said issue interfaces is a compliant material.

9. The system of claim 1 wherein said negative pressure applicator is an annular member having an internal lumen to be disposed about an operative site.

10. The system of claim 1 wherein said negative pressure applicator comprises a plurality of negative pressure applicator members configured to be disposed symmetrically around at least a portion of an operative site.

11. The system of claim 1 wherein said negative pressure applicator comprises a plurality of negative pressure applicator members configured to be disposed asymmetrically around at least a portion of an operative site.

12. The system of claim 1 further comprising at least a portion of said negative pressure supply is compliant, such that negative pressure applicator is held normal to said soft tissue.

13. The system of claim 1 wherein said negative pressure supply is flexible.

14. The system of claim 1 wherein said negative pressure supply is rigid.

15. The system of claim 1 further comprising a second negative pressure supply.

16. The system of claim 16 further comprising a second negative pressure applicator coupled to said second negative pressure supply.

17. A method for the manipulation of soft tissue, said method comprising:
disposing a negative pressure applicator proximate to a surgical site in soft tissue, said negative pressure applicator being coupled to a negative pressure supply;
applying a negative pressure to said soft tissue thereby applying traction to said surgical site;
inserting a surgical instrument through a central axis of said helical rigid negative pressure supply; and
manipulating tissue at said surgical site.

18. The method of claim 18 wherein said negative pressure supply is rigid.

19. The method of claim 17 wherein said negative pressure supply is helical.

20. The method of claim 17 further comprising manipulating said surgical instrument outside of a circumference of said helical rigid negative pressure supply.
